(19) United States
(12) Patent Application Publication
(10) Pub. No.: US 2025/0303943 A1
(43) Pub. Date: Oct. 2, 2025

(54) CHAIR, VIBRATOR, AND MOVABLE OBJECT

(71) Applicant: Panasonic Automotive Systems Co., Ltd., Kanagawa (JP)

(72) Inventors: Shinya KAGAWA, Osaka (JP); Hiroyuki MORIMOTO, Osaka (JP); Takayuki DAN, Mie (JP); Hidetoshi ASADA, Osaka (JP)

(73) Assignee: Panasonic Automotive Systems Co., Ltd., Kanagawa (JP)

(21) Appl. No.: 19/082,956

(22) Filed: Mar. 18, 2025

(30) Foreign Application Priority Data
Mar. 28, 2024 (JP) 2024-054097

(51) Int. Cl. B60N 2/70; B60N 2/90

(52) U.S. Cl. CPC B60N 2/7047; B60N 2/90

(57) ABSTRACT

A chair includes: a cushion member; a spring member disposed along the cushion member; and a vibrator disposed between the cushion member and the spring member. The vibrator includes a fixer that fixes the vibrator to the spring member. The vibrator vibrates the spring member based on an input electrical signal.

### CROSS REFERENCE TO RELATED APPLICATION

The present application is based on and claims priority of Japanese Patent Application No. 2024-054097 filed on Mar. 28, 2024.

### FIELD

The present disclosure relates to a chair capable of applying vibration to a seated person, a vibrator included in the chair, and a movable object that includes the chair capable of applying vibration to the seated person.

### BACKGROUND

Conventionally, there has been a cushion that is attached to a chair and in which a vibration unit generating vibration (sound) is incorporated, as disclosed in Patent Literature (PTL) 1.

### CITATION LIST

### Patent Literature

PTL 1: Japanese Unexamined Utility Model Application Publication No. 2-096945

### SUMMARY

However, the cushion according to PTL 1 can be improved upon.

The present disclosure provides a chair, a vibrator, and a movable object that are capable of improving upon the above related art.

A chair according to one aspect of the present disclosure includes: a cushion member; a spring member disposed along the cushion member; and a vibrator disposed between the cushion member and the spring member. The vibrator includes a fixer that fixes the vibrator to the spring member, and the vibrator vibrates the spring member based on an input electrical signal.

A vibrator according to one aspect of the present disclosure is a vibrator disposed between a cushion member and a spring member that is disposed along the cushion member. The vibrator includes: a fixer that fixes the vibrator to the spring member. The vibrator vibrates the spring member based on an input electrical signal.

A movable object according to one aspect of the present disclosure includes: a chair including: a cushion member; a spring member disposed along the cushion member; and a vibrator disposed between the cushion member and the spring member. The vibrator includes a fixer that fixes the vibrator to the spring member, and the vibrator vibrates the spring member based on an input electrical signal.

The chair, vibrator, and movable object according to one aspect of the present disclosure are capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a perspective view illustrating a chair.

FIG. 2 is a perspective view transparently illustrating a cushion member included in the chair.

FIG. 3 is a perspective view illustrating spring members and vibrators.

FIG. 4 is a diagram schematically illustrating a movable object.

FIG. 5 is a cross-sectional view illustrating an inside structure of a vibrator.

FIG. 6 is a diagram schematically illustrating a movable object in another example.

### DESCRIPTION OF EMBODIMENT

Hereinafter, one or more embodiments of the chair, vibrator, and movable object according to the present disclosure will be described below, with reference to the drawings. Note that the following one or more embodiments are provided as examples to illustrate the present disclosure and are not intended to limit the present disclosure. For example, the shapes, structures, materials, structural elements, relative positional relationships, connections, numerical values, mathematical expressions, the details of each step in a method, the order of each step in the following one or more embodiments, etc. are mere examples and may include content not described below. Moreover, geometric expressions such as parallel, perpendicular, and orthogonal are sometimes used, but these expressions do not imply mathematical rigor and include practically permissible errors, deviations, etc. Moreover, expressions such as simultaneous, identical, and being the same also include practically acceptable ranges.

Moreover, the drawings are schematic illustrations with emphasis, omission, or proportional adjustments as appropriate to illustrate the present disclosure and are different from the actual shapes, positional relationships, and ratios. Moreover, an X axis, a Y axis, and a Z axis, which may be shown in the figures, are the orthogonal coordinates set arbitrarily for illustration purposes. In other words, the Z axis is not necessarily an axis along the vertical direction, and the X and Y axes are not necessarily in the horizontal plane.

Moreover, in the following, a plurality of embodiments may be comprehensively described as one embodiment. Moreover, part of the following descriptions is described as one or more optional structural elements related to the present disclosure.

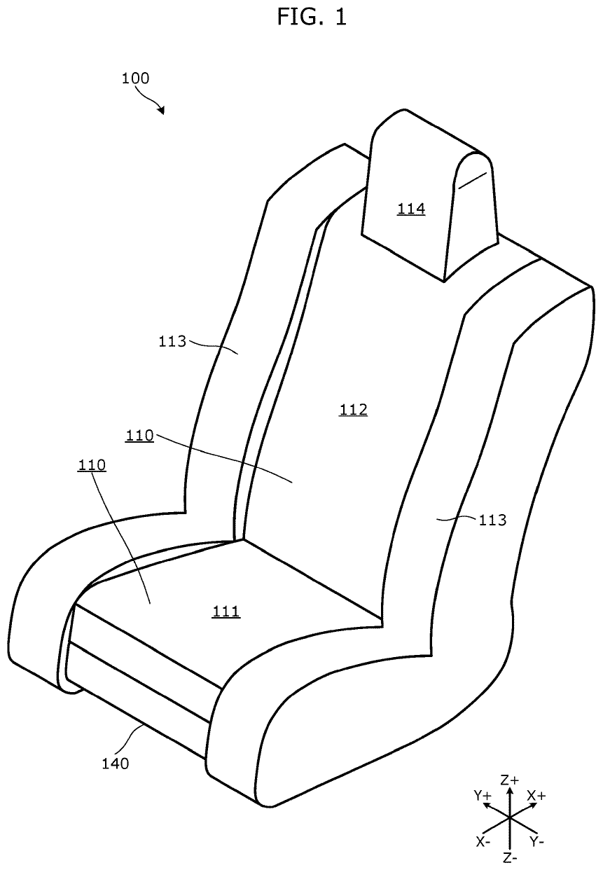

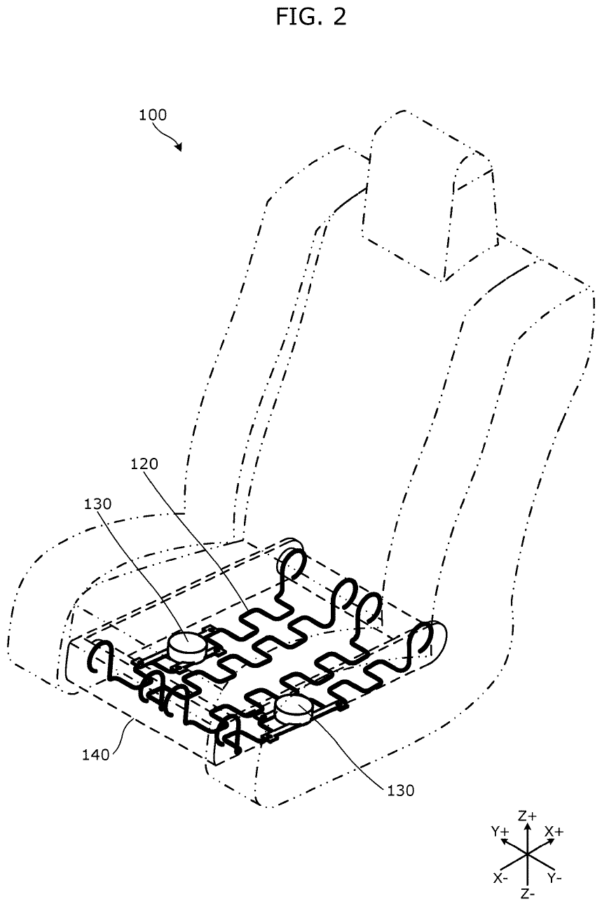

FIG. 1 is a perspective view illustrating chair 100. FIG. 2 is a perspective view transparently illustrating cushion member 110 included in chair 100. Chair 100 includes cushion member 110, spring member 120, and vibrator 130.

Chair 100 may be of any type. In the present embodiment, chair 100 includes seat 111, backrest 112, side supports 113, and headrest 114. Note that it suffices that chair 100 includes at least seat 111. Chair 100 may be a chair such as a stool that does not include backrest 112, one or more side supports 113, and headrest 114. Chair 100 may include one or more armrests. Moreover, in the present embodiment, chair 100 is to be attached to movable object 200 (see FIG. 4), such as a vehicle, via fundamental structural member 140. Therefore, chair 100 does not include one or more legs that maintain seat 111 at a predetermined height, but may be chair 100 including one or more legs.

Cushion member 110 is a member that has flexibility and elasticity, and provided, for example, below buttocks including thighs of a seated person, behind the back of the seated person, one or more sides of the body of the seated person, below one or more arms including elbows of the seated person, and behind the head of the seated person. Cushion member 110 supports a portion of the body of the seated person. The material included in cushion member 110 may be any material. An example of the material may be urethane foam. There may be cases where the surface of cushion member 110 is covered with a cover material. The cover material is a member that covers the outer surface of cushion member 110 and is sheet-shaped harder than cushion member 110. The cover material maintains the shape of cushion member 110 without impairment of the cushioning characteristics of cushion member 110, and improves the design of chair 100. The material of the cover material may be any material. Examples of the cover material may include woven fabric, synthetic leather, and natural leather. In the present embodiment, cushion member 110 is attached to fundamental structural member 140 that is responsible for the structural strength of chair 100. In the present embodiment, cushion member 110 is provided to each of seat 111, backrest 112, side supports 113, and headrest 114. Fundamental structural member 140 holds cushion members 110 provided to seat 111, backrest 112, side supports 113, and headrest 114. Note that FIG. 2 illustrates only fundamental structural member 140 of seat 111.

Spring member 120 is a member disposed opposite to a seated person with respect to cushion member 110 and disposed along cushion member 110. Spring member 120 has elasticity stronger than cushion member 110, and supports a portion of the body of the seated person via cushion member 110. In the present embodiment, spring member 120 is attached to the frame-shaped fundamental structural member 140 disposed in a lower portion of seat 111. Note that spring member 120 is provided to a fundamental structural member (not illustrated) that is disposed not only in a lower portion of seat 111. Spring member 120 may be attached to a fundamental structural member that may also be disposed in a rear portion of backrest 112, at least one of a rear portion or a side portion of at least one side support 113, a rear portion of headrest 114, a lower portion of at least one armrest, etc.

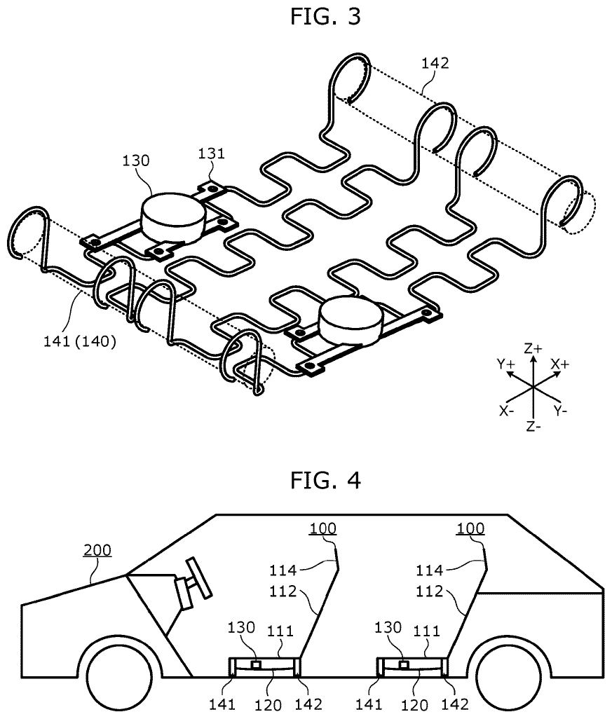

Spring member 120 may be of any type. Examples of the type of spring member 120 may include an S spring, a wire grid, and a formed wire illustrated in FIG. 2 and FIG. 3. In the present embodiment, a formed wire that is adopted as spring member 120 is obtained by forming a hard steel wire, which is one of spring steel wires, into a desired shape. In a lower portion of seat 111 of chair 100, a plurality of spring members 120 are disposed. As illustrated in FIG. 3, in the front-and-rear direction (X-axis direction in the figure) of fundamental structural member 140 disposed in a lower portion of seat 111 of chair 100, each of spring members 120 is attached across front side member 141 located on the front side and rear side member 142 located on the rear side. Each of front side member 141 and rear side member 142 has a beam shape, and fundamental structural member 140 has a frame shape.

Note that spring members 120 may also include a so-called subwire that connects the plurality of formed wires. In other words, vibrator 130 may be attached to a subwire included in spring members 120.

Vibrator 130 is a device disposed between cushion member 110 and spring member 120, and applies vibration including sound to a seated person who is seated on chair 100. Vibrator 130 includes fixer 131 that fixes vibrator 130 to spring member 120. Vibrator 130 generates vibration that is to be transmitted to the seated person by vibrating spring member 120 via fixer 131, based on an input electrical signal. In the present embodiment, spring member 120 is disposed in a lower portion of seat 111. Chair 100 includes two vibrators 130, and each vibrator 130 is fixed to a corresponding one of two portions of spring member 120 opposite thighs of a person seated on chair 100. Moreover, each vibrator 130 is fixed to a portion of spring member 120 opposite a portion of a thigh of a person seated on chair 100, the portion being offset toward a buttock from a central portion of the thigh, i.e., a portion of seat 111 offset toward backrest 112 from a central portion of seat 111 in the front-and-rear direction.

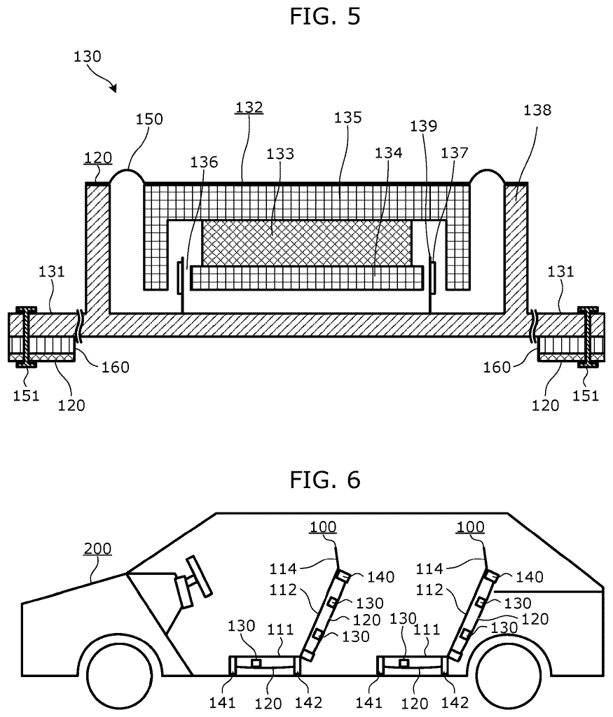

FIG. 5 is a cross-sectional view illustrating an inside structure of vibrator 130. Note that in FIG. 5, although the main body part of vibrator 130 and fixers 131 are illustrated in one figure, the cross section of each fixer 131 is taken along a plane different from the plane of the cross section of the main body part of vibrator 130.

Each vibrator 130 is a so-called actuator (exciter) that is attached to spring member 120 and vibrates spring member 120 based on an input electrical signal. Vibrator 130 may be of any type. Examples of the type of vibrator 130 include a vibrator including a magnet and a coil, a vibrator including a piezoelectric element, and a vibrator including a magnetostrictor. In the present embodiment, vibrator 130 is a magnet type actuator including magnetic circuit 132, frame 138, and suspension 150.

Magnetic circuit 132 includes magnet 133 that is a magnetized cylindrical permanent magnet; top plate 134 that has a disk shape and attached to one end surface of magnet 133 with its circumference projecting from magnet 133; and bottom plate 135 having a bottomed cylindrical shape and attached to an end surface located opposite to top plate 134 with respect to magnet 133. Bottom plate 135 houses magnet 133 and top plate 134 coaxially, and magnetic gap 136 having an annular shape is formed between top plate 134 and bottom plate 135. In magnetic gap 136, coil 137 is disposed.

Frame 138 is a structural member that holds magnetic circuit 132 and coil 137. Frame 138 may be of any shape. In the present embodiment, frame 138 has a bottomed cylindrical shape in a full view. At a position surrounded by an edge portion of an opening end of frame 138, the outer circumferential edge of bottom plate 135 of magnetic circuit 132 is positioned. Frame 138 and bottom plate 135 are bonded to be coaxially disposed via suspension 150 having an annular shape.

An electrical signal indicating vibration or sound is input to coil 137. Interaction between magnetic force generated in coil 137 and magnetic force present in magnetic gap 136 generates force in accordance with the electrical signal, in the winding axis direction of coil 137. In the present embodiment, coil 137 is wound around the circumference of bobbin 139 having a cylindrical shape, and provided to the central portion of frame 138 via bobbin 139.

With the configuration described above, vibrator 130 causes magnetic circuit 132 and frame 138 to reciprocate relative to the winding axis direction of coil 137 based on the force generated in coil 137 to generate vibration. Vibrator 130 can apply vibration in accordance with an electrical signal to spring member 120 joined to frame 138.

As a structure of vibrator 130, magnetic circuit 132 of an internal magnetic type has been described, but this example should not be construed as limiting. Magnetic circuit 132 included in vibrator 130 may be an external magnetic type.

Fixer 131 is a part for attaching vibrator 130 to spring member 120. Fixer 131 is provided to protrude from frame 138 of vibrator 130. In the present embodiment, vibrator 130 includes a plurality of fixers 131, and each of fixers 131 has a different length so that fixer 131 can be fixed to each spring member 120 bent in a predetermined shape. Any method may be used for joining vibrators 130 and spring members 120. In the present embodiment, fixer 131 and spring member 120 is fixed by fastening member 151. If vibrator 130 and spring member 120 are fixed firmly by bonding, etc., the bonded part cannot follow the expansion and contraction of the spring when a person sits down or stands up, and the bonded part may break. Therefore, the structure for connecting vibrator 130 and spring member 120 may be a structure having flexibility and compliance.

In the present embodiment, filling member 160 is disposed between fixer 131 and a portion of spring member 120. Fixer 131 is a portion of vibrator 130. Filling member 160 is a member that fills a gap between vibrator 130 and spring member 120. Filling member 160 is in an elastically deformed state when vibrator 130 is attached to spring member 120. Filling member 160 suppresses contact sound, such as so-called rattle noise, caused by intermittent contact between vibrator 130 and spring member 120, which is caused by vibration, etc. applied to chair 100 due to travel of movable object 200.

Filling member 160 is bonded to at least one of vibrator 130 or spring member 120. The bonding method may be any method. Examples of bonding may include bonding with a double-sided tape or an adhesive agent. Although any material may be included in filling member 160, a material that flexibly follows deformation or distortion of spring member 120 when a person sits on chair 100, and flexibly follows a change in distance between vibrator 130 and spring member 120 when vibration is applied to chair 100 may be used. Specifically, examples of a material included in filling member 160 may include rubber and elastomer, and more specifically, for example, ethylene propylene rubber foam may be included.

Note that the present disclosure should not be construed to be limited to the above-described embodiment. For example, another embodiment realized by arbitrarily combining structural elements or excluding one or more structural elements described in this written description may be included as an embodiment of the present disclosure. Furthermore, variations obtained by various modifications to the foregoing embodiment that can be conceived by a person having ordinary skill in the art, that are within the scope of the essence of the present disclosure, that is, the intended teachings of the recitations of the claims, are also included in the present disclosure.

For example, as illustrated in FIG. 6, vibrator 130 may be provided not only in a lower portion of seat 111, but also attached to spring member 120 disposed along the rear side of backrest 112, which is the rear side of cushion member 110 included in backrest 112. Moreover, vibrator 130 may also be attached to spring member 120, which is disposed in, for example, at least one of a rear portion or a side portion of at least one side support 113, a rear portion of headrest 114, and a lower portion of at least one armrest.

Moreover, vibrator 130 may be fixed without filling member 160. Vibrator 130 may be fixed to spring member 120 by, for example, bonding, welding, or crimping. In this case, fixer 131 may be flexible or include an expandable and contractable mechanism to thereby enable fixer 131 to follow the deformation of spring member 120 that occurs when a person sits on chair 100 or when vibration is applied to chair 100.

Moreover, filling member 160 may be disposed not only between fixer 131 and spring member 120, but also may be disposed between the main body of vibrator 130 and spring member 120.

Moreover, although an automobile is given as an example of movable object 200, movable object 200 may be a bus, a truck, an airplane, a ship, a train, construction machinery, agricultural machinery, etc.

### Conclusion

Chair 100 according to a first aspect includes: cushion member 110; spring member 120 disposed along cushion member 110; and vibrator 130 disposed between cushion member 110 and spring member 120. Vibrator 130 includes fixer 131 that fixes vibrator 130 to spring member 120. Vibrator 130 vibrates spring member 120 based on an input electrical signal.

With the first aspect, vibrator 130 vibrates spring member 120, which is at least harder than cushion member 110. Therefore, the vibration can be transmitted to a seated person stably regardless of the body size, weight, sitting posture, etc. of the seated person on chair 100.

Chair 100 according to a second aspect includes the first aspect, and includes: filling member 160 that is disposed in an elastically deformed state between a portion of vibrator 130 and a portion of spring member 120 and suppresses sound caused by intermittent contact between vibrator 130 and spring member 120.

With the second aspect, unusual sound caused by intermittent contact between vibrator 130 and spring member 120 due to vibration, etc. applied to chair 100 can be suppressed.

Chair 100 according to a third aspect includes the first aspect or the second aspect. Vibrator 130 is fixed to a portion of spring member 120 opposite a portion of a thigh of a person seated on chair 100, the portion being offset toward a buttock from a central portion of the thigh.

With the third aspect, the vibration generated by vibrator 130 can be effectively transmitted to the seated person and provides the seated person with a sense of presence and excitement.

Chair 100 according to a fourth aspect includes any one of the first to third aspects. Vibrator 130 is fixed to each of two portions of spring member 120 opposite thighs of a person seated on chair 100.

With the fourth aspect, by inputting different signals to the two vibrators 130, for example, it is possible to apply different vibrations to the left and right of the seated person according to the stereoscopic image, thereby enhancing the so-called stereoscopic sense of presence.

Chair 100 according to a fifth aspect includes any one of the first to fourth aspects. Vibrator 130 is fixed to a portion of spring member 120 that is opposite a back of a person seated on chair 100.

With the fifth aspect, it is possible to apply vibration on the back of the seated person which comes into relatively wide contact with chair 100.

Vibrator 130 according to a sixth aspect is attached to chair 100 according to any one of the first to fifth aspects, and is vibrator 130 disposed between cushion member 110 and spring member 120 that is disposed along cushion member 110. Vibrator 130 includes: fixer 131 that fixes vibrator 130 to spring member 120. Vibrator 130 vibrates spring member 120 based on an input electrical signal.

With the sixth aspect, vibrator 130 can vibrate a relatively rigid spring member 120. Therefore, vibrator 130 can transmit vibration to the seated person stably regardless of the body size, weight, sitting posture, etc. of the seated person on chair 100.

The vibrator according to a seventh aspect includes the sixth aspect and includes: filling member 160 that is disposed between a portion of vibrator 130 and a portion of spring member 120 and suppresses sound caused by intermittent contact between vibrator 130 and spring member 120.

With the seventh aspect, unusual sound caused by intermittent contact between vibrator 130 and spring member 120 due to vibration, etc. applied to chair 100 can be suppressed.

Movable object 200 according to an eighth aspect includes chair 100 according to any one of the first to fifth aspects.

According to the eighth aspect, it is possible to effectively transmit the vibration generated by vibrator 130 to a seated person even in movable object 200 where vibration and noise occur.

While various embodiments have been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims are incorporated herein by reference in their entirety: Japanese Patent Application No. 2024-054097 filed on Mar. 28, 2024.

### Industrial Applicability

The present disclosure can be used for, for example, chairs provided in listening rooms, chairs provided in theaters, and chairs provided in movable objects.

1. A chair comprising:
a cushion member;
a spring member disposed along the cushion member; and
a vibrator disposed between the cushion member and the spring member, wherein
the vibrator includes a fixer that fixes the vibrator to the spring member, and
the vibrator vibrates the spring member based on an input electrical signal.

2. The chair according to claim 1, comprising:
a filling member that is disposed in an elastically deformed state between a portion of the vibrator and a portion of the spring member and suppresses sound caused by intermittent contact between the vibrator and the spring member.

3. The chair according to claim 1, wherein
the vibrator is fixed to a portion of the spring member opposite a portion of a thigh of a person seated on the chair, the portion being offset toward a buttock from a central portion of the thigh.

4. The chair according to claim 1, wherein
the vibrator is fixed to each of two portions of the spring member opposite thighs of a person seated on the chair.

5. The chair according to claim 1, wherein
the vibrator is fixed to a portion of the spring member that is opposite a back of a person seated on the chair.

6. A vibrator disposed between a cushion member and a spring member that is disposed along the cushion member, the vibrator comprising:
a fixer that fixes the vibrator to the spring member, wherein
the vibrator vibrates the spring member based on an input electrical signal.

7. The vibrator according to claim 6, comprising:
a filling member that is disposed between a portion of the vibrator and a portion of the spring member and suppresses sound caused by intermittent contact between the vibrator and the spring member.

8. A movable object comprising:
a chair including:
a cushion member;
a spring member disposed along a surface of the cushion member; and
a vibrator disposed between the cushion member and the spring member, wherein
the vibrator includes a fixer that fixes the vibrator to the spring member, and
the vibrator vibrates the spring member based on an input electrical signal.
